(19) United States
(12) Patent Application Publication
(10) Pub. No.: US 2011/0228932 A1
(43) Pub. Date: Sep. 22, 2011

(54) DATA TRANSMISSION CIRCUIT

(75) Inventors: Kiyotaka IWAMOTO, Kyoto (JP); Shinobu MACHIDA, Kyoto (JP); Takayuki MATSUI, Osaka (JP); Kohei HASHIGUCHI, Shiga (JP)

(73) Assignee: PANASONIC CORPORATION, Osaka (JP)

(21) Appl. No.: 13/150,540

(22) Filed: Jun. 1, 2011

Related U.S. Application Data
(63) Continuation of application No. PCT/JP2009/006133, filed on Nov. 16, 2009.

(30) Foreign Application Priority Data
Dec. 16, 2008 (JP) 2008-319511

(51) Int. Cl. H04N 7/167

(52) U.S. Cl. 380/205

(57) ABSTRACT

A data transmission circuit analyzes video data and a pixel clock input from a video/audio signal processor, and determines whether the signals are valid or not. If a signal is invalid, the data transmission circuit generates and outputs a TMDS signal based on dummy video data and a dummy pixel clock internally generated as pseudo signals. Accordingly, a state in which an invalid signal is being output can be prevented, and the time required to output video can be reduced because an additional device authentication is not performed.

### CROSS-REFERENCE TO RELATED APPLICATION

This is a continuation of PCT International Application PCT/JP2009/006133 filed on Nov. 16, 2009, which claims priority to Japanese Patent Application No. 2008-319511 filed on Dec. 16, 2008. The disclosures of these applications including the specifications, the drawings, and the claims are hereby incorporated by reference in its entirety.

### BACKGROUND

The present disclosure relates to data transmission circuits etc. which switch output data to dummy data based on external input signals.

In recent years, the widespread digitization has caused devices which process digital content to communicate with each other through an interface called high-definition multimedia interface (HDMI), which provides uncompressed high-speed digital transmission. The HDMI interface achieves high-speed data transmission by using a technology called transition minimized differential signaling (TMDS). The TMDS technology allows data to be transmitted using four types of channels, to which three color signals RGB and a synchronization signal having a clock frequency are respectively assigned. This signal information and the clock frequency meet the definition of EIA-861-B standard (see Non-Patent Document 1).

In addition, the HDMI standard uses a device authentication procedure and a content protection scheme defined in the high-bandwidth digital content protection system (HDCP) standard (see Non-Patent Document 2) to protect content information transmitted.

FIG. 1 is a block diagram illustrating a configuration of a conventional HDMI communication system. The HDMI communication system shown in FIG. 1 includes a transmitter device 100 such as a digital versatile disc (DVD) player, and a receiver device 120 such as a digital television receiver. The transmitter device 100 and the receiver device 120 are connected together through an HDMI cable 130.

There are various methods to obtain transmission content information from the outside world. As an example, the transmitter device 100 of FIG. 1 uses a media drive 101 when the content information is obtained from a medium such as a DVD or a secure digital (SD) card, and uses a tuner 102 when the content information is obtained from information over a radio wave. The obtained content information is input to a video/audio signal processor 103. The video/audio signal processor 103 outputs signal information of video data including the three color signals RGB, audio data including audio information, and pixel clock having a clock frequency, to an HDMI LSI. The HDMI LSI encrypts the input signal information in a copyright protector 105, converts the result into a TMDS signal in an output controller 106, and then outputs the TMDS signal over an HDMI cable 130. Operations in the HDMI LSI are performed through a control register 104. The control register 104 is controlled using a CPU in the video/audio signal processor 103.

After device authentication is performed between the transmitter device 100 and the receiver device 120, the receiver device 120 obtains information required to decode information which is being received, decodes the received information, and outputs a video output and an audio output. Decoding of received information requires decode information which is generated based on the pixel clock and on the video data synchronized with the pixel clock, and if the video data or the pixel clock is invalid, an authentication error occurs because valid decode information is not generated. Thus, the video/audio signal processor 103 synchronizes the video data with the pixel clock before inputting the video data and the pixel clock to the HDMI LSI, thereby preventing an authentication error.

However, even if the signal information input from the video/audio signal processor 103 is in an invalid signal state due to a problem, the conventional transmitter device 100 encrypts the input signal information, and transmits the encrypted information to the receiver device 120. When the receiver device 120 decodes the received data, the decoding operation cannot be successfully completed because the information has been encrypted using an invalid signal, thereby causing an authentication error to occur. Thus, a re-authentication operation is performed, and therefore, it takes more time to output the video. Even if the decoding process can be successfully completed, the signals are not valid, and thus a situation occurs in which video is not correctly reproduced. In addition, there has been a problem in that, for example, since the situation in which the video/audio signal processor 103 is outputting an invalid signal cannot be detected, the malfunction state cannot be restored.

In view of such a problem, a technology is described in Patent Document 1 which counts the interval of the horizontal synchronization signal Hsync and the interval of the vertical synchronization signal Vsync of the input signal, confirms whether the counts are normal for output signal information, and interrupts the output operation when it is determined that the input signal is invalid.

The referenced non-patent and patent documents are as follows:
Patent Document 1: Japanese Patent Publication No. 2007-174041
Non-Patent Document 1: Video Formats and Waveform Timings (Chapter 4), in EIA STANDARD, A DTV Profile for Uncompressed High Speed Digital Interfaces, EIA/CEA-861-B (Revision of EIA/CEA-861-A)
Non-Patent Document 2: HDCP Specification Revision 1.3, Digital Content Protection, LLC, http://www.digital-cp.com/home

### SUMMARY

However, even though the technology described in Patent Document 1 can prevent an invalid signal from being transmitted, an output portion cannot detect an output of an invalid signal, and thus a situation in which a malfunction occurs remains. A problem exists in that, even if an output of an invalid signal can be detected, a retransmission operation of a TMDS signal is performed between the transmitter device and the receiver device, thereby causing device authentication to be performed, and thus causing a delay in outputting the video.

The various embodiments of the present invention have been made in view of the foregoing, and it is an object of the present invention to provide a data transmission device etc. which can inform the outside world of a detection of an invalid signal, and reduce the time required to output video because an additional device authentication is not performed.

A data transmission circuit according to one embodiment of the present invention includes a copyright protector configured to encrypt input data, and to perform device authentication with an external data receiver device, an output controller configured to convert the data encrypted by the copyright protector into a transition minimized differential signaling (TMDS) signal, and to output the TMDS signal to the data receiver device, an information storage configured to store setting information on each of output formats of the data to be input to the copyright protector, a signal analyzer configured to compare the setting information stored in the information storage with a pixel clock and video data input from an external video/audio signal processor, a dummy signal generator configured to generate a dummy pixel clock and dummy video data as pseudo signals equivalent to an output setting based on the setting information stored in the information storage, and a signal switch section configured to switch which of the pixel clock input from the video/audio signal processor and the dummy pixel clock generated by the dummy signal generator is input to the copyright protector, and which of the video data input from the video/audio signal processor and the dummy video data generated by the dummy signal generator is input to the copyright protector, based on a result of the comparison by the signal analyzer. With this configuration, the outside world can be informed that an invalid signal has been detected, and the time required to output video can be reduced because an additional device authentication is not performed.

In a data transmission circuit according to another embodiment of the present invention, in addition to that of the first embodiment of the present invention, the output controller continuously outputs the pixel clock and the video data output from the video/audio signal processor when the signal switch section switches an operation so that the copyright protector receives the pixel clock and the video data input from the video/audio signal processor while outputting the TMDS signal based on the dummy pixel clock and the dummy video data generated by the dummy signal generator. With this configuration, the signals can be switched without any interruption of the transmission of the TMDS signal.

In a data transmission circuit according to still another embodiment of the present invention, in addition to that of the second embodiment of the present invention, the output controller outputs the pixel clock and the video data input from the video/audio signal processor without device authentication with the data receiver device by the copyright protector when the signal switch section switches the operation so that the copyright protector receives the pixel clock and the video data input from the video/audio signal processor while outputting the TMDS signal based on the dummy pixel clock and the dummy video data generated by the dummy signal generator. With this configuration, since switching of the signals does not cause any device authentication, the time required to output video can be reduced.

In a data transmission circuit according to a further embodiment of the present invention, in addition to that of the first embodiment of the present invention, the setting information stored in the information storage can be changed by an input from the video/audio signal processor. With this configuration, flexible processing can be provided even when format information has been updated due to a revision of the standard or the specification etc.

A data transmission circuit according to a still further embodiment of the present invention further includes, in addition to that of the first embodiment of the present invention, a control register configured to control outputs of the information storage, of the signal analyzer, and of the dummy signal generator. With this configuration, the information storage can update the setting information stored therein by using the control register; the signal analyzer can inform other components of a result of the analysis by using the control register, and obtain the setting information to be obtained from the information storage from other components by using the control register; and the dummy signal generator can obtain the setting information to be obtained from the information storage from other components by using the control register.

In a data transmission circuit according to a still further embodiment of the present invention, in addition to that of the first embodiment of the present invention, the dummy signal generator generates the dummy pixel clock and the dummy video data using an oscillator. With this configuration, a valid TMDS signal can be output even when an invalid signal is input.

A data transmission circuit according to the present invention can inform the outside world of a detection of an invalid signal, and reduce the time required to output video because an additional device authentication is not performed.

### BRIEF DESCRIPTION OF THE DRAWINGS

FIG. 1 is a block diagram illustrating a configuration of a conventional HDMI communication system.

FIG. 2 is a block diagram illustrating a configuration of HDMI LSI 200 according to an example embodiment of the present invention.

FIG. 3 is a diagram illustrating an example of the setting information which is set based on output format information.

FIG. 4 is a diagram to explain an example of a synchronization operation performed in the signal switch section 206.

### DETAILED DESCRIPTION

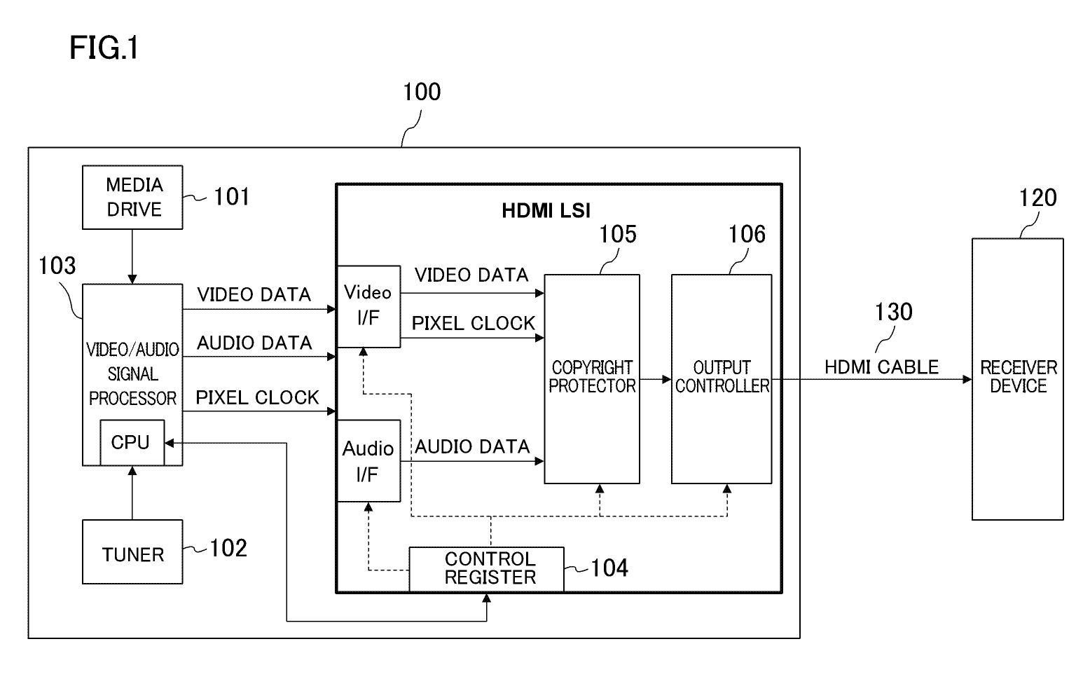

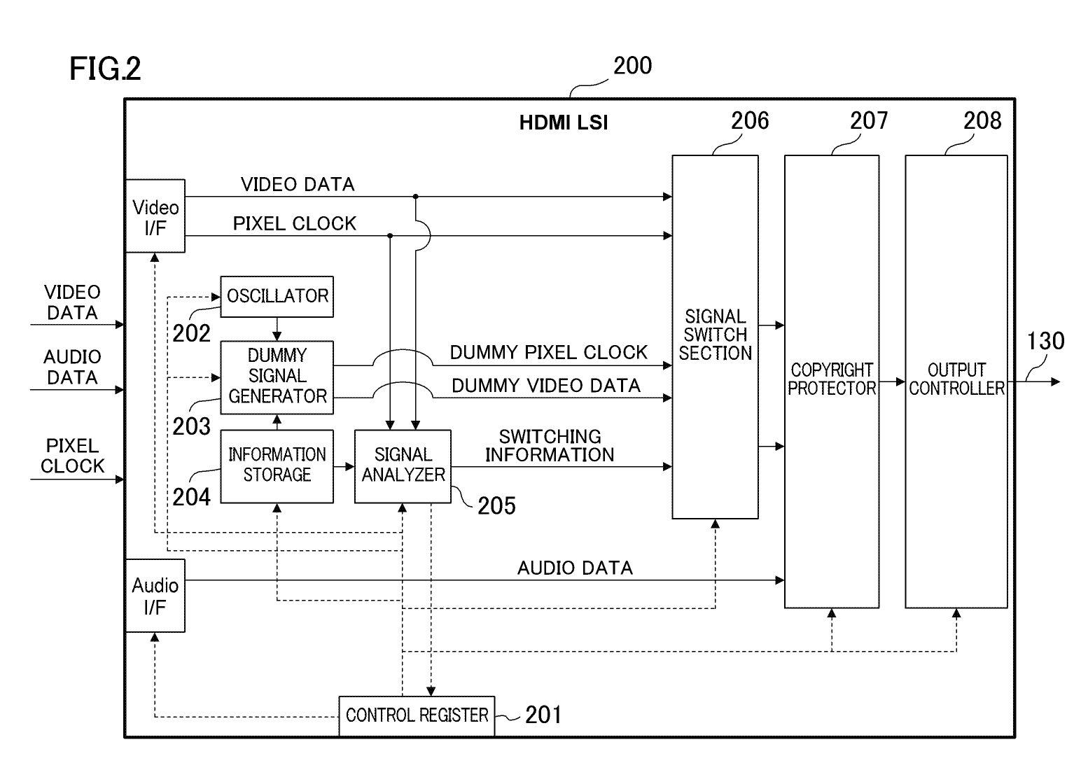

The schematic configuration of an HDMI communication system according to an embodiment of the present invention is similar to that shown in FIG. 1. However, in this embodiment, an HDMI LSI 200 shown in FIG. 2 is used instead of the HDMI LSI in the transmitter device 100 shown in FIG. 1. The HDMI LSI 200 shown in FIG. 2 includes a control register 201, an oscillator 202, a dummy signal generator 203, an information storage 204, a signal analyzer 205, a signal switch section 206, a copyright protector 207, and an output controller 208.

The dummy signal generator 203, the information storage 204, the signal analyzer 205, the signal switch section 206, the copyright protector 207, and the output controller 208 can usually be implemented using hardware (e.g., a dedicated circuit). Specifically, the system of this embodiment can be implemented by an MPU and a memory etc. Operations to perform various functions are typically described in the form of software, and the software can be recorded on a recording medium such as a read-only memory (ROM).

The copyright protector 207 encrypts data input from the video/audio signal processor 103, and performs device authentication with the receiver device 120. These operations are performed by control commands issued by the control register 201. The data encryption and the device authentication described herein comply with the HDCP standard. The copyright protector 207 may inform the video/audio signal processor 103 of the result of device authentication. There are various methods to inform the video/audio signal processor 103 of the result of device authentication. For example, the control register 201 includes a register which stores a result of device authentication, and the video/audio signal processor 103 checks the value. This configuration allows the result of device authentication to be known. The informing method is not limited to such a configuration, but other methods may be used.

The output controller 208 converts the data input from the copyright protector 207 into a TMDS signal, and outputs the TMDS signal to the receiver device 120. When the TMDS signal is output, the video signal and the audio signal can be muted. Requests for these operations are processed by control commands issued by the control register 201. In a mute state, the receiver device 120 displays black video, and provides silent audio.

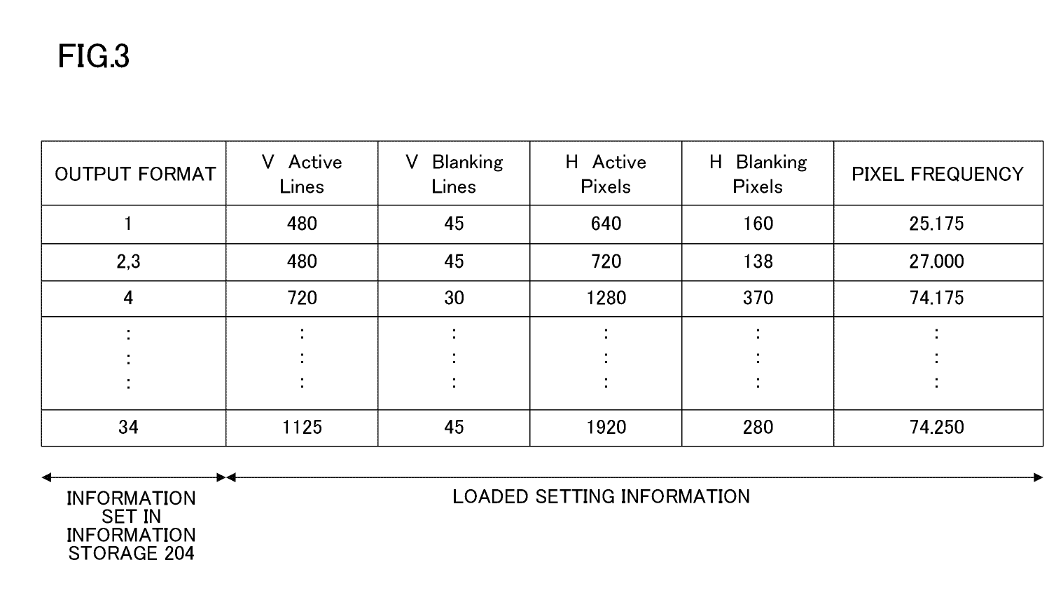

The information storage 204 stores setting information on each of output formats of the data to be input to the copyright protector 207. There are various types of information which are required to check the video information input to the copyright protector 207. For example, as shown in FIG. 3, V active lines, V blanking lines, H active pixels, H blanking pixels, and the pixel frequency, which are defined in EIA/CEA-861-B, are output based on output format information, and using such information allows signal information to be analyzed. The stored information is not limited thereto, but any other method may be used. Moreover, the content of the stored information can be externally updated, and thus, even if the output format information is changed due to a revision of the standard or the specification etc., processing can be adaptively adjusted. These operations are performed by control commands issued by the control register 201.

The signal analyzer 205 compares the setting information input from the information storage 204 with the video data and the pixel clock input from the video/audio signal processor 103, and informs the video/audio signal processor 103 of the result of the comparison. There are various methods of comparison. For example, it is preferred that the signal analyzer 205 obtain the numbers of horizontal and vertical synchronization signals from the video data input from the video/audio signal processor 103, and compare these numbers with the numbers of horizontal synchronization signals (H active pixels and H blanking pixels) and vertical synchronization signals (V active lines and V blanking lines), and the pixel frequency in the setting information to see whether the values match or not. The comparison method is not limited thereto, but other methods may be used. There are various informing methods. For example, a register for setting the result of the comparison is provided in the control register 201, and the video/audio signal processor 103 checks the value. This configuration allows the result of the comparison to be known. The informing method is not limited thereto, but other methods may be used.

In addition, the signal analyzer 205 informs the signal switch section 206 of switching information. The switching information includes information on whether the video data and the pixel clock input from the video interface are to be used, or the dummy video data and the dummy pixel clock input from the dummy signal generator 203 are to be used. This control is performed by control commands issued by the control register 201.

The dummy signal generator 203 generates a dummy pixel clock and dummy video data as pseudo signals equivalent to an output setting based on the setting information input from the information storage 204. The dummy pixel clock is generated using the oscillator 202. The frequency of the generated clock is the same as the pixel frequency specified in the setting information. The dummy signal generator 203 synchronizes the dummy pixel clock generated by the oscillator 202 with the dummy video data, and then outputs the dummy pixel clock and the dummy video data. This control is performed by control commands issued by the control register 201.

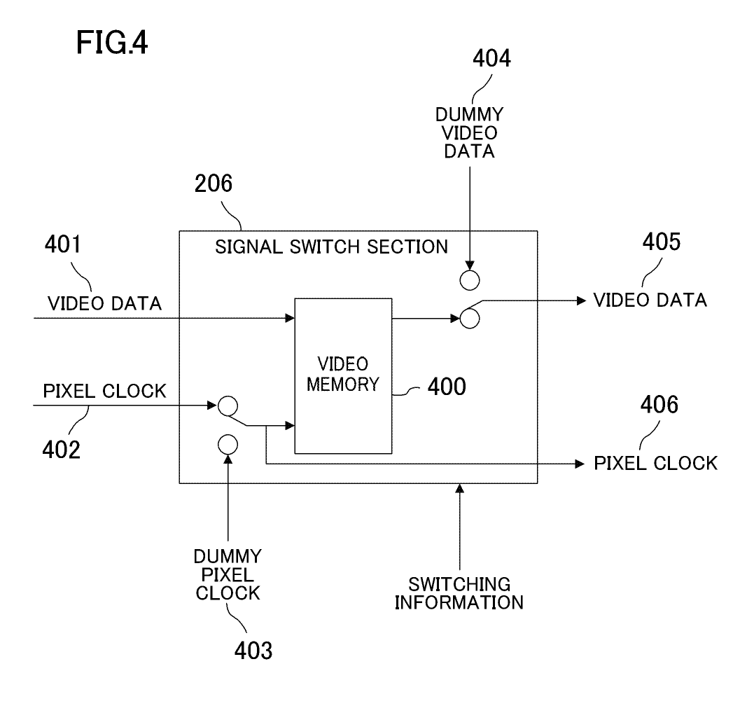

The signal switch section 206 switches between a process in which the video data and the pixel clock input from the video interface are input to the copyright protector 207 and a process in which the dummy video data and the dummy pixel clock input from the dummy signal generator 203 are input to the copyright protector 207, based on the switching information from the signal analyzer 205. Since the video data input to the copyright protector 207 needs to be synchronized with the pixel clock, a synchronization operation is performed in the signal switch section 206. There are various methods to synchronize the signals with each other. For example, as shown in FIG. 4, the signal switch section 206 includes a video memory 400 which temporarily stores the video data 401. If the switching information indicates a detection of valid signals, the video data 401 input from the video/audio signal processor 103 is once stored in the video memory 400, a signal synchronization operation is performed using the pixel clock 402 input from the video/audio signal processor 103, and then the video data 401 and the pixel clock 402 are used as the video data 405 and the pixel clock 406 of the output signals. Meanwhile, if the switching information indicates a detection of an invalid signal, the dummy video data 404 and the dummy pixel clock 403 generated by the dummy signal generator 203 are used as the video data 405 and the pixel clock 406 of the output signals, and when the switching information changes to indicate a detection of valid signals, information in the video memory 400 is once cleared, and the video data 405 for the output signal is switched to the video data 401. Then, a signal synchronization operation is performed using the dummy pixel clock 403, and the video data 401 and the dummy pixel clock 403 are used as the video data 405 and the pixel clock 406 of the output signals. The switching operation and the synchronization operation are not limited thereto, but other methods may be used. This control is performed by control commands issued by the control register 201.

According to this embodiment, the HDMI LSI 200 can switch the video signal information without interrupting the transmission of a TMDS signal as described below.

The HDMI LSI 200 analyzes the video data and the pixel clock input from the video/audio signal processor 103 in the signal analyzer 205, and the result of a determination of whether the signals are valid or invalid is set to the control register 201.

If a result of the analysis by the signal analyzer 205 shows that valid signals are input, the signals input from the video/audio signal processor 103 are input to the copyright protector 207, and the output controller 208 uses these signals in output processing as the HDMI signal.

Meanwhile, if a result of the analysis by the signal analyzer 205 shows that an invalid signal is input, the dummy video data and the dummy pixel clock generated in the dummy signal generator 203 are input to the copyright protector 207, and the information in the control register 201 is set to represent a mute state of the video signal. Accordingly, the output controller 208 outputs the video signal as the HDMI signal in a mute state. Since the receiver device 120 outputs the dummy video data, black data is preferred for the dummy video data. However, other data may be used.

While an HDMI signal using the dummy video data is being output, the video/audio signal processor 103 obtains the result of the analysis from the signal analyzer 205 through the control register 201, and if the result of the analysis shows a detection of an invalid signal, signals are generated again, and the video data and the pixel clock are input again.

When the signal analyzer 205 analyzes the input signals and detects valid signals, the switching information is set to represent a detection of valid signals. In response to this, the signal switch section 206 switches the signal to be input to the copyright protector 207 from the dummy video data to the video data input from the video/audio signal processor 103. After the completion of the switching operation, the signal switch section 206 sets the information in the control register 201 so as to represent an unmuted state of the video signal.

The output controller 208 unmutes the video signal which is being output by the unmuted state information set in the control register 201.

As described above, according to this embodiment, the HDMI LSI 200 can switch the video signal information without interrupting the transmission of a TMDS signal.

In this embodiment, the HDMI LSI 200 can perform device authentication with the receiver device 120 while outputting the HDMI signal using the dummy video data, and can output data encrypted by the copyright protector 207 from the output controller 208. When the HDMI LSI 200 inputs again valid video data while the receiver device 120 decodes the dummy video data which is being received, a switching operation of video data is performed. Synchronization between the video data and the pixel clock output from the signal switch section 206 allows an encryption operation to be normally performed in the copyright protector 207 even after the switching operation, and thus no errors occur during the decode operation in the receiver device 120. Accordingly, device authentication due to an error occurrence is not performed, thereby allowing the receiver device 120 to output the video more rapidly.

In this embodiment, the HDMI LSI 200 may be configured such that the content of the setting information internally stored in the information storage 204 can be updated through the control register 201. Thus, the information storage 204 can store latest setting information. In addition, the setting information may be obtained from the control register 201, and the obtained content may be used in the signal analyzer 205 and the dummy signal generator 203.

In this embodiment, each operation (each function) may be implemented by centralized processing by a single device (e.g., a system, an integrated circuit, etc.), or may be implemented by decentralized processing by a plurality of devices.

It is understood that the present invention is not limited to the particular embodiments described above, but various modification and changes may be made thereto without departure from the broader spirit and scope of the invention.

As described above, each of the data transmission circuits according to the present invention is advantageous in that it can inform the outside world of a detection of an invalid signal, and can reduce the time required to output video because an additional device authentication is not performed, and thus is useful for data transmission devices etc.

What is claimed is:

1. A data transmission circuit, comprising:
a copyright protector configured to encrypt input data, and to perform device authentication with an external data receiver device;
an output controller configured to convert the data encrypted by the copyright protector into a transition minimized differential signaling (TMDS) signal, and to output the TMDS signal to the data receiver device;
an information storage configured to store setting information on each of output formats of the data to be input to the copyright protector;
a signal analyzer configured to compare the setting information stored in the information storage with a pixel clock and video data input from an external video/audio signal processor;
a dummy signal generator configured to generate a dummy pixel clock and dummy video data as pseudo signals equivalent to an output setting based on the setting information stored in the information storage; and
a signal switch section configured to switch which of the pixel clock input from the video/audio signal processor and the dummy pixel clock generated by the dummy signal generator is input to the copyright protector, and which of the video data input from the video/audio signal processor and the dummy video data generated by the dummy signal generator is input to the copyright protector, based on a result of the comparison by the signal analyzer.

2. The data transmission circuit of claim 1, wherein
the output controller continuously outputs the pixel clock and the video data output from the video/audio signal processor when the signal switch section switches an operation so that the copyright protector receives the pixel clock and the video data input from the video/audio signal processor while outputting the TMDS signal based on the dummy pixel clock and the dummy video data generated by the dummy signal generator.

3. The data transmission circuit of claim 2, wherein
the output controller outputs the pixel clock and the video data input from the video/audio signal processor without device authentication with the data receiver device by the copyright protector when the signal switch section switches the operation so that the copyright protector receives the pixel clock and the video data input from the video/audio signal processor while outputting the TMDS signal based on the dummy pixel clock and the dummy video data generated by the dummy signal generator.

4. The data transmission circuit of claim 1, wherein
the setting information stored in the information storage can be changed by an input from the video/audio signal processor.

5. The data transmission circuit of claim 1, further comprising:
a control register configured to control outputs of the information storage, of the signal analyzer, and of the dummy signal generator.

6. The data transmission circuit of claim 1, wherein
the dummy signal generator generates the dummy pixel clock and the dummy video data using an oscillator.

7. A data transmission device, comprising:
the data transmission circuit of claim 1; and
a video/audio signal processor configured to output data to be processed in the data transmission circuit to the data transmission circuit.
